(19) United States
(12) Patent Application Publication
(10) Pub. No.: US 2022/0270123 A1
(43) Pub. Date: Aug. 25, 2022

(54) DATACENTER WITH DECENTRALIZED MANAGED NEGOTIATION BETWEEN DATACENTER AND DEVICES

(71) Applicant: Virtual Power Systems Inc., Milpitas, CA (US)

(72) Inventors: Karimulla Raja Shaikh, Milpitas, CA (US); Brandon Gillespie, Milpitas, CA (US)

(73) Assignee: Virtual Power Systems Inc., Milpitas, CA (US)

(21) Appl. No.: 17/668,330

(22) Filed: Feb. 9, 2022

Related U.S. Application Data
(60) Provisional application No. 63/147,254, filed on Feb. 9, 2021.

(51) Int. Cl. G06Q 30/02

(52) U.S. Cl. CPC G06Q 30/0207

(57) ABSTRACT

Disclosed techniques include systems and methods for managed negotiation between a controller of a datacenter and devices receiving resources as directed by the controller in the datacenter. The controller can identify a need for reduction in power provision or any other resource, and can make offers to device(s) requesting the device consumes less power. The offer also includes compensation paid by the controller to the device in exchange for the power reduction.

### CROSS-REFERENCE TO RELATED PATENT APPLICATIONS

The present disclosure claims priority to U.S. Provisional Patent Application No. 63/147,254 entitled “DATACENTER POWER MANAGEMENT WITH DISTRIBUTED POLICY INTERACTION” filed Feb. 9, 2021 which is incorporated herein by reference in its entirety.

### FIELD OF ART

This application relates generally to power management and more particularly to datacenter power management.

### BACKGROUND

The computing and other electrical equipment that is required to support the information technology (IT) operations associated with an organization is housed in facilities called datacenters. The datacenters are centralized facilities that are sometimes called “server farms”. The datacenters support a wide range of data processing and other applications, data storage and data access, and networking infrastructure, among many other processing requirements. Organizations including online retailers, financial institutions, search providers, research laboratories, universities, hospitals, and other computing-intensive organizations, conduct operations using their datacenters. A typical datacenter houses a vast network of heterogeneous, critical systems, the continuous operation of which is vital to the success of the organization. The critical systems can include servers, storage devices, routers, and other IT equipment. The critical systems are often mounted in rows of equipment racks, which are also referred to data racks or information technology racks. The proprietary, confidential, and personal information stored on and processed by these critical systems must be protected from loss or theft. As a result, the security and reliability of datacenters and the information within them is a top priority for the organizations. Further, the wide range of processing requirements and the quantity of the processing equipment cause datacenters to consume copious amounts of electrical power. In fact, the amount of power consumed by a typical datacenter often accounts for a substantial portion of an organization's operating budget, to cover the cost of electricity.

The computer systems found within datacenters are constructed from an immense number of electrical and electronic components. These components include printed circuit boards populated with integrated circuits or “chips”; mass storage devices based on magnetic optical, or electronic storage technologies; networking interfaces; and processors. The processors include central processing units (CPUs), graphics processing units (GPUs), storage or memory management units (MMUs), among many others. Given the precise and ever-increasing power requirements demanded by these components, reliable and efficient power delivery is crucial to operation of the datacenters. Further, the power requirements can change dramatically depending on the processing requirements occurring at a given time. For many organizations, the computer systems must meet or exceed statutory requirements for reliability and availability. Financial institutions and healthcare organizations are required by law to meet certain standards for the protection of data maintained and processed by the organizations. Additionally, educational organizations and retail businesses face other statutory requirements which mandate that certain standards must be met to protect personal, educational, and consumer data. The statutory requirements dictate stringent safeguards on the physical and technical security of personal data by requiring physical security of the systems and encryption of the data. Regardless of the computer system and infrastructure requirements of a given type of institution, key infrastructure specifications must be met in order to address the important issues of availability, reliability, job load, and other organizational requirements of datacenters.

### SUMMARY

Embodiments of the present disclosure are directed to a computer-implemented method for managing negotiation for resource provision in a datacenter. The method includes providing a resource to devices in the datacenter, wherein a controller in the datacenter manages provision of the resource to the devices in the datacenter. The method also includes determining a resource modification condition in the datacenter, formulating a resource modification and an offer of compensation based, at least in part, upon the resource modification condition, and communicating the resource modification and the offer of compensation in exchange for the resource modification to the devices. The method also includes receiving a rejection of the offer of compensation from zero or more of the devices, and receiving an acceptance of the offer of compensation from zero or more of the devices. The method also includes implementing the resource modification to accepting devices, and distributing compensation to the accepting devices according to the offer of compensation.

Further embodiments of the present disclosure are directed to a system for managing negotiation of resources in a datacenter. The system includes a controller configured to provide a resource to one or more devices in the datacenter, the resource comprising at least one of power and data. The controller is further configured to communicate with the one or more devices, and further wherein the controller is configured to modify provision of the resource to the device. The system also includes a processor and a memory storing one or more computer-readable instructions executable by the processor to perform acts. The acts include establishing a resource modification goal for the devices, the resource modification goal defining a modification of provision of the resource to the devices, formulating an offer for one or more of the devices, the offer comprising a resource modification and a compensation offer in exchange for the resource modification, and communicating the offer to the one or more devices. The acts also include receiving an answer to the offer from the one or more devices, implementing the resource modification to one or more of the devices accepting the offer, and distributing the compensation to the one or more of the devices accepting the offer.

Still further embodiments of the present disclosure are directed to a system for managing negotiation of resources in a datacenter. The system includes a controller configured to provide power to one or more devices in the datacenter. The controller communicates with the one or more devices and modifies provision of the power to the device. The system also includes a processor and a memory storing one or more computer-readable instructions executable by the processor to perform acts. The acts include monitoring at least one of a cost and an availability of power, and if cost or availability of power exceeds a predefined threshold, identifying a power modification condition having a quantifiable power reduction goal based, at least in part, upon at least one of the cost and availability of power. The acts also include based at least in part upon the power modification condition, formulating a reduction offer to one or more of the devices. The reduction offer includes a power reduction and a compensation. The acts further include communicating the reduction offer to one or more of the devices, receiving an affirmative answer from one or more of the devices, and in response to the affirmative answer, implementing the power reduction and delivering the compensation.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a schematic illustration of a system for managing negotiation for resources between devices according to embodiments of the present disclosure.

FIG. 2 is a block diagram of a method for managing negotiation for resources in a datacenter according to embodiments of the present disclosure.

FIG. 3 is a block diagram of a method for managing negotiation for resources in a datacenter according to embodiments of the present disclosure in which a device initiates a resource request to a controller in the datacenter.

FIG. 4 is a block diagram of a method for identifying devices in a datacenter with which to negotiate for resource provision according to embodiments of the present disclosure.

FIG. 5 is a block diagram of a method for managing negotiation for resources in a datacenter according to embodiments of the present disclosure in which devices in the datacenter initiate a resource modification and offer compensation in return.

FIG. 6 shows data rack power and control communication.

FIG. 7 illustrates fractional power sharing and control.

FIG. 8 shows peak shaving.

FIG. 9 illustrates 2N redundancy for power.

FIG. 10 shows limit allocation.

FIG. 11 illustrates hierarchical allocation of power control.

FIG. 12 shows control system internals.

FIG. 13 illustrates JavaScript Object Notation (JSON) code for policies.

FIG. 14 shows a system for datacenter power bursting.

FIG. 15 illustrates processing of software-defined power policies.

FIG. 16 is a system diagram for power management with distributed policy interaction.

### DETAILED DESCRIPTION

Datacenters can contain hundreds, thousands, or in some cases millions of devices including computers, servers, and other associated equipment, such as disk arrays, data backup, routers, and other networking and storage equipment. Managing distribution of power for efficiency and reliability within a datacenter can be extremely challenging. At first blush, one might think that adding up the power requirements associated with each device within the datacenter would be the basis for designing a power distribution plan. However, since not all devices in a datacenter are typically operating at full capacity at a given time, a lower requirement for power management can be imagined. But what would the lower requirement be? Average power requirements are meaningless because the power loads vary dynamically, often significantly and frequently. Instead, power management becomes a problem of determining power needs based on planned equipment usage, scheduled processing jobs, contractual agreements, and so on. This disclosure is directed to systems and methods for managing the varying dynamic needs of the various devices in a datacenter in an efficient, communicative way using managed negotiation for resources between devices.

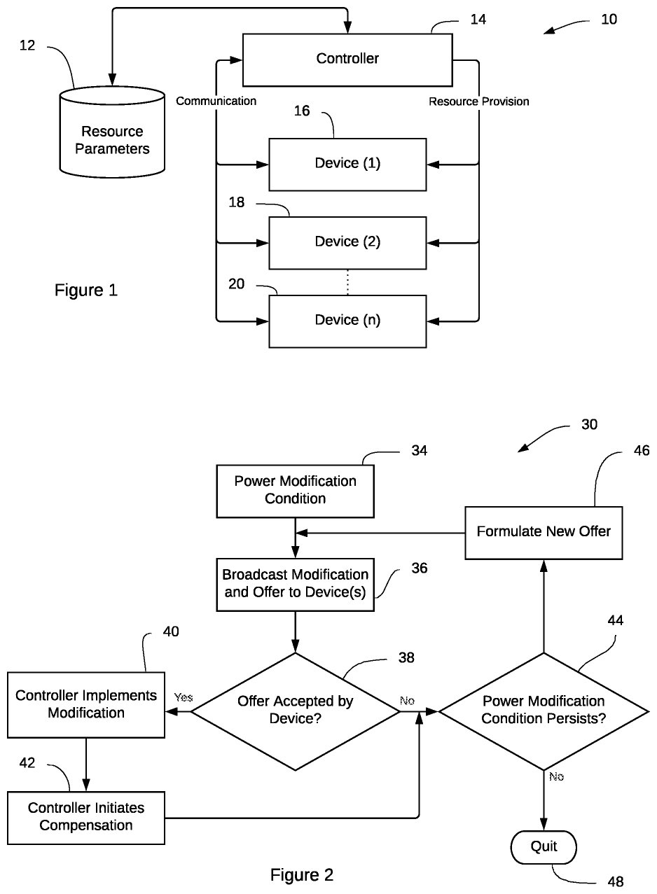

FIG. 1 is a schematic illustration of a system 10 for managing negotiation for resources between devices according to embodiments of the present disclosure. The system 10 includes a database 12 for storing resource parameters such as price, availability, source, type, and a history of when and to which device the resource has been provided by the system 10. The resource in question can be any deliverable resource, such as power, cooling, bandwidth, electromagnetic frequencies, communication lines, video monitoring, analytics, or any other resource that can be provided to devices in a datacenter. Such resources are known as “transferrable datacenter resources,” meaning a resource that can be transferred between and among controllers and devices in a datacenter. Means for transferring the transferrable datacenter resources include electrical lines, power lines, ethernet communication lines, wireless transmission lines, and HVAC ducts. The means for transferring the transferrable datacenter resources also includes attention of monitoring individuals and/or equipment, bandwidth access, etc.

The system 10 includes a controller 14 that manages the distribution of the resource to one or more devices, such as a first device 16, a second device 18, up to and including an nth device 20. The devices can be any one or more of servers, server racks, CPUs, memories, hard drives, cooling equipment including internal cooling devices such as fans as well as HVAC equipment, lights, communication apparatuses, or any other conceivable device that consumes the resource in the datacenter. There can be any number of devices, and devices may comprise two or more other devices in a cluster, such as a server which includes a CPU, memory, etc, in which case each device within the server may be considered an individual device, and also together the server can be considered a device.

The controller 14 is connected to the devices to provide communication. The communication lines may be a hard line such as an Ethernet network, or another communication mechanism such as a wireless connection. The controller 14 is also configured to provide resources to the devices as needed by the various devices at various times, and subject to the operating procedures disclosed herein. The controller 14 may also be two or more separate pieces of equipment. For example, the controller 14 may comprise a communication module that executes the communication to the devices, and a resource provision module that executes the resource provision. These two modules may or may not be housed in the same physical object; however, the two modules operate together in concert to achieve the objectives herein.

FIG. 2 is a block diagram of a method 30 for managing negotiation for resources in a datacenter according to embodiments of the present disclosure. In this description the resource in question is power; however, it is to be appreciated that any resource may take the place of power in a given embodiment. At 34 a power modification condition takes place. The power modification condition may be any event or instruction that establishes a need to modify one or more resource parameters, such as price, rate of delivery, amount, schedule, pathway, source, supplier, etc. In an example used for illustration, suppose the cost of power rises, and the datacenter wishes to stay on budget and to accomplish this there needs to be a cut in power distribution for the next period of time. For example, suppose the datacenter needs to cut power by 5% for the next 24 hours. This is the power (or resource) modification condition.

At 36 the modification is broadcast to one or more devices. The broadcast can also include an offer to the devices that will compensate the device(s) (in reality the compensation reaches the owner/operator of the device and not the device itself) in exchange for their agreement to receive less power. The broadcast and offer can be accomplished via established communication pathways. The broadcast and offer can be made to groups of the devices or to all devices. In some embodiments devices can be organized into groups based on their willingness and ability to respond to an offer. In some embodiments some devices can store their own parameters for the type and quantity of offer each device will entertain, and in some embodiments these parameters are shared with the controller and the datacenter operator. In some embodiments the devices can preemptively establish offers they are willing to accept, such that when the broadcast comes no further decision is needed on part of the device, and the offer is instantly and automatically accepted and the resource modification is implemented with equal dispatch.

In other embodiments the devices are not equipped to instantly or preemptively accept an offer, and instead the devices may initiate communication with its operator which may be a remote device and/or operator that will make the decision to accept or reject the offer, or even to formulate a counter offer which can be communicated back to the controller. The parameters of the offers and of the resource modification conditions can vary quickly and frequently. Accordingly an automated response will offer the advantage of agility by allowing changes to be made quickly and frequently—perhaps more frequently than what would be possible with a human decision involved in the process.

At 38 the method 30 continues at 38 by receiving an answer from one or more devices accepting or rejecting the offer. If the offer is not accepted, at 44 a check is performed to determine whether or not the power modification condition persists. In a datacenter with many devices, it is possible that a sufficient number of the devices accept the offer and the result is that the power modification condition has been alleviated, even if some of the devices do not accept the offer. In some cases, depending on the severity of the power modification condition and the offer, the power modification condition is alleviated even before some of the devices have responded to the offer. In such cases the controller may have authority to cancel the offer at any time before the offer is implemented.

If the offer is accepted, at 40 the controller implements the modification to the power provision to the device. At 42 the controller initiates the compensation to the device according to preestablished arrangements. Recall that the resource in question can be any type of resource provided to the devices or even received from the devices, and the compensation can vary equally and can include money, as well as in-kind compensation such as a modification to a different resource. For example, the controller may make an offer to a device to reduce power consumption in exchange for access to improved cooling equipment, access to more advantageous bandwidth, etc. The possibilities for negotiation are many.

In addition, the resource in question may in fact be two or more resources together, combined and packaged in a useful way. The resources can be the subject of the same negotiation, wherein both resources are modified. A mathematical combination of two or more resources can be used, such as the sum of kilowatt hours and data transfer. Any two or more resources can be combined into any number of combinations that can be part of the negotiation. In other embodiments each resource can be negotiated separately.

At 44 if the power modification condition persists, the controller can formulate a new offer at 46, which can then be broadcast to the devices at 36 and the method 30 repeats with the new offer. For each iteration of the offer, devices that accept the offer can be included or omitted from the new offer. For example, if the controller offers $10 for a power reduction in the first offer, some devices will accept the offer and there is no need to offer these devices additional compensation for the same reduction. However, a further reduction may be the subject of a secondary offer, and the further reduction will help to achieve the overall goal of the datacenter in which case the second offer can be sent to devices that have already accepted the first offer. If the power modification condition no longer persists at 48 the method quits. The reduction goal has been met, and a state of equilibrium is achieved until the next power modification condition arises.

The operating procedures for making, accepting, and implementing offers and counteroffers can be communicated to the devices ahead of time, and can even be subject to contractual obligations. The devices can thus be managed quickly without undue delays. Also, offers can include other incentives to the devices, such as for the first one hundred devices that accept the offer, an additional compensation will be provided. Such incentives can be included in a contractual obligation to preemptively accept the offer. The datacenter can then have certain devices that will accept a reduction in exchange for more compensation.

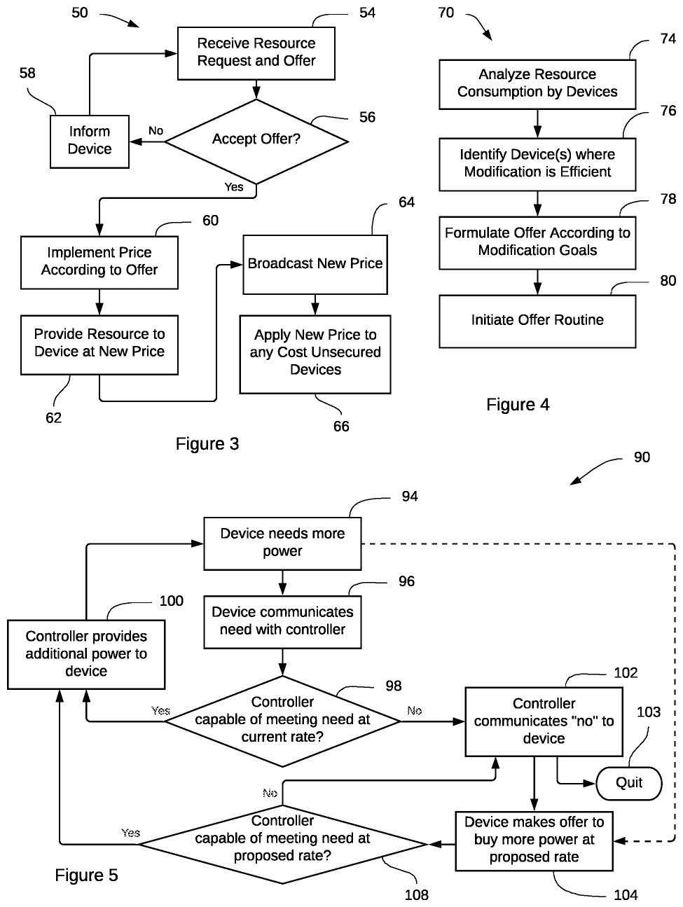

FIG. 3 is a block diagram of a method 50 for managing negotiation for resources in a datacenter according to embodiments of the present disclosure in which a device initiates a resource request to a controller in the datacenter. At 54 the controller receives a request from a device for more (or less) of a particular resource. The request can be accompanied by an offer from the device to compensate the datacenter via a controller for the resource modification, where an increased resource allotment involves payment by the device, and a decrease in resource allotment involves a decrease in payment from the device, or even a payment by the controller to the device. At 56 the controller evaluates the offer and accepts or rejects the offer. At 58 if the offer is rejected the device is so informed, and the device can update the offer and try again or abandon the attempt. At 60 if the offer is accepted, the controller implements the price and at 62 provides the resource at the new price.

The new price can be broadcast to other devices in the datacenter. The new price can be established as the new going rate for the resource for any new resource provisions. Furthermore, any devices that do not have contracted with the controller to maintain their current price can be referred to as being “cost unsecured.” At 66 the new price can be applied to any cost unsecured devices. Securing a price for a resource itself is an asset that can be purchased by the devices to avoid an unwanted increase in price, and to mitigate the risk of increase energy costs or other factors that can cause an increase in the price for the resource. The devices and controller can have certain limits that govern behavior in the event of a price change. For example, a device may be operating at the price of $100 for the resource and may also have flexibility to increase up to $120 if other devices offer to increase their price, and without additional agreement from the device operator. But the device may have a limit at the $120 mark in which case the price for that device to access the resource cannot increase above $120 without further input from the device and/or its operator. Many types of arrangements can be established between the operator of the device and the operator of the datacenter that are carried out in real time by their respective equipment: the device(s) and the controller.

Power modification conditions, more generally referred to as resource modification conditions, can be defined by the datacenter as any factor influencing the availability and/or price of the resource. Examples include power outages, power price increases, regulatory changes, contractual obligations, unexpected equipment failure, an information security breach, natural disasters such as fires, floods, and earthquakes, geopolitical strife, or any other event that can have an affect on the availability and/or price of the resource. Including datacenter budgeting concerns, and even a purely arbitrary desire of the datacenter to cut costs or improve efficiency.

The broadcasting of events related to the managed negotiation of resource delivery according to the present disclosure can be carried out using datacenter-wide communications, targeted inquiries to a certain device or groups of devices. Devices may be grouped according to current resource parameters. For example, the controller may observe that a subset of the devices consuming a certain resource are consuming significantly more of the resource than other devices, so an offer can be formulated to target those outlying devices. Other devices need not be informed of the offer.

FIG. 4 is a block diagram of a method 70 for identifying devices in a datacenter with which to negotiate for resource provision according to embodiments of the present disclosure. The method 70 includes at 74 analyzing resource consumption by devices in the datacenter. Analyzing includes historical data, rates of consumption, periodicity of consumption, such as periods of high consumption or low consumption. Analyzing also includes comparative analysis between devices or groups of devices. The analysis can be between similar devices, or can be device type-agnostic focusing on the resource in question, and not the device itself or the operation of the device. Analysis can also include a metric of the productivity of that device, wherein the resource is the raw material. Such productivity can be measured at the device or can also be reported by the device operator.

At 76 the results of the analysis is identifying a device or devices that exhibit usage patterns that suggest there is a more efficient pattern. For example, a group of devices may be consuming notably more power than other similar devices, and may not be achieving a commensurate productivity. The parameters that define an inefficiency that can be remedied through the systems and methods of the present disclosure can be arbitrarily constructed. In some embodiments machine learning techniques can be implemented to identify groups of devices that can be subject to an offer for resource modification.

At 78 the method 70 includes formulating an offer for the identified group of devices. For example, the offer can be formulated by calculating a total amount of the resource that would be “spared” if the devices accept the offer and the modification is implemented. Thus the offer can be designed with a reasonable expectation of success, and avoids the problem of implementing an offer that does not yield the desired efficiency gains.

Formulating the offer can also include an analysis of a likelihood of the device accepting the offer. On one end of the spectrum, some devices may be contractually bound to accept the offer, and on the other extreme end some devices may have the datacenter contractually bound not to even offer modifications at all. In between there can be a continuous gradient of acceptance likelihood. The datacenter can have this behavior documented in historical data that can be used to forecast a likelihood of acceptance. The product of the likelihood of acceptance and the magnitude of the reduction in the offer can be solved for to formulate an appropriate offer. At 80 the offer routine is initiated by executing the offer as shown in FIG. 2.

In other embodiments it can be determined that even a slight modification is worthwhile, even such a modification that does not meet the predetermined goals. The datacenter can make these half-measures and can benefit from the increased efficiency it will afford despite not reaching the full goals. It is also valuable to recall that these calculations and offers can be frequently formulated and can be automated such that in a given day there may be multiple offers, acceptances, and modifications. It is conceivable that in a given hour there are hundreds or thousands of such offers, in which case the price and provision of the resource approaches a continuous curve, and not a stepped, discrete plot.

FIG. 5 is a block diagram of a method 90 for managing negotiation for resources in a datacenter according to embodiments of the present disclosure in which devices in the datacenter initiate a resource modification and offer compensation in return. At 94 the device encounters a need for additional power, or any other resource. Reference is made here to power without loss of generality and other resources (including two or more resources in a combination) can be the subject of the modification request and offer. The device at 96 communicates this need with the controller responsible for managing such a request. At 98 the controller analyzes the request and determines if it is capable of meeting the request without a modification to the price of the resource. If so, at 100 the controller provides the additional power to the device. If, however, the controller cannot meet the request at 102 the controller communicates this “no” to the device. The device can quit at 103, or can make an offer at 104 to purchase more power. In some embodiments the device can skip directly to 104 to make an offer with the initial communication to the controller, as represented by the dashed line. The offer can be calculated by the device according to the desires of the operator of the device. The offer can be automated according to rules. The offer can be made according to a pre-determined increment established by the controller to prevent small offers from becoming too frequent and insignificant. Similar to a minimum purchase requirement.

At 108 the controller evaluates the offer. If no, the controller so communicates at 102 and the device can quit or reevaluate and make a new offer. If the controller accepts the offer at 100 the controller provides the power to the device. The power modification request can be for a reduction in power in exchange for compensation to flow from the controller to the device in exchange. Accordingly, as shown and described herein, the offer can be made by either the device or the controller. The offer may be for an increase or reduction in provision. The resource in question can be anything provided to or from the device or the controller. The compensation can also be any form of compensation, including money, in kind contributions, scheduling, access, marketing promotions, or any other good and valuable consideration as broadly defined in the law.

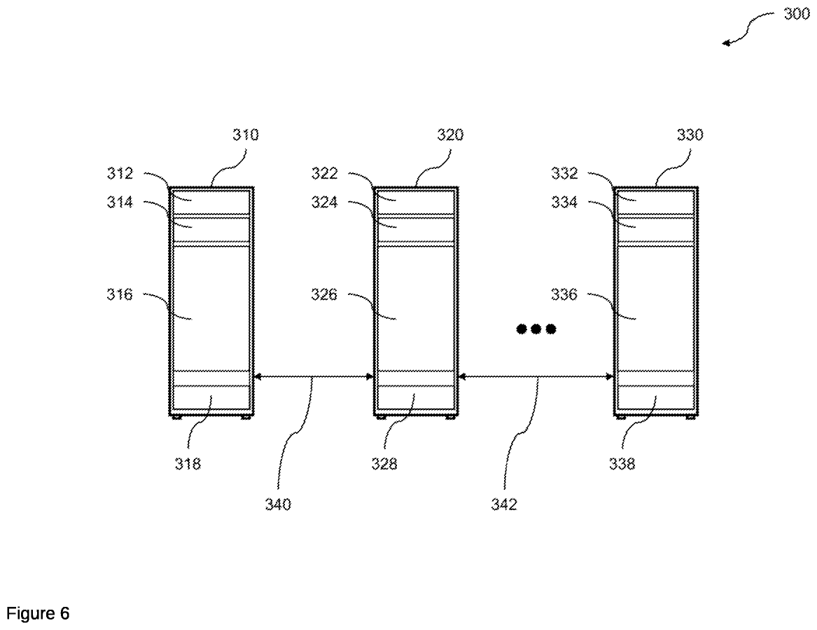

FIG. 6 shows data rack power and control communication. A datacenter can include multiple data racks, where each data rack can include processors, servers, data storage devices, networking equipment, and so on. Power, whether AC power or DC power, is provided to the electrical equipment in the data racks in order for the equipment to operate. Power distribution among the data racks and communication among the data racks can be controlled based on datacenter power management with distributed policy interaction. Example 300 includes three data racks, indicated as rack 310, rack 320, and rack 330. The example 300 can employ datacenter power management with distributed policy interaction. While three data racks are shown in example 300, in practice, there can be more or fewer data racks. The data rack 310 includes a power cache 312, a server 314, a server 316, and a power supply 318. The power supply 318 can be used for AC-DC conversion and/or filtering of power to be used by the servers 314 and 316, as well as replenishment of the power cache 312. In embodiments, the power cache 312 includes an array of rechargeable batteries. In embodiments, the batteries include, but are not limited to, lead-acid, nickel metal hydride (NiMH), lithium ion (Li-ion), nickel cadmium (NiCd), and/or lithium-ion polymer (Li-ion polymer) batteries. Similarly, the data rack 320 includes a power cache 322, a server 324, a server 326, and a power supply 328. Furthermore, the data rack 330 includes a power cache 332, a server 334, a server 336, and a power supply 338. The data racks are interconnected by communication links 340 and 342. The communication links can be part of a local area network (LAN). In embodiments, the communication links include a wired Ethernet, Gigabit Ethernet, or another suitable communication link. The communication links enable each data rack to send and/or broadcast current power usage, operating conditions, and/or estimated power requirements to other data racks and/or upstream controllers such as a cluster controller. Thus, in the example 300, a power cache can be located on each of the multiple data racks within the datacenter. In embodiments, the power cache includes multiple batteries distributed across the multiple data racks.

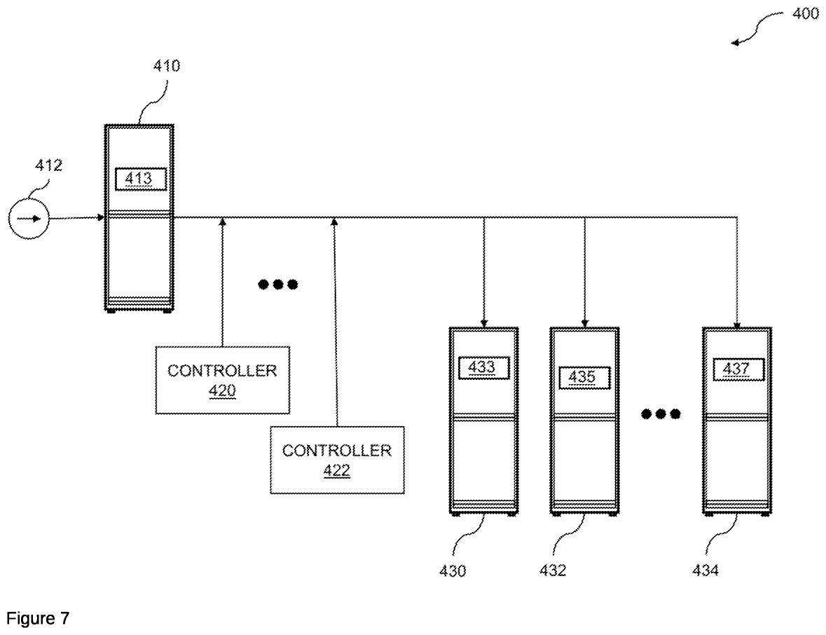

FIG. 7 illustrates fractional power sharing and control. Fractional power sharing and control can be used to handle peak power load demands when a source such as a grid power source is unable to provide 100 percent of the power required at a given time. The grid power can be supplemented or augmented by an additional power source, where the additional power source can include locally generated power, backup power, cached power, and so on. Fractional power sharing and control can be based on datacenter power management with distributed policy interaction. In the example 400, the power source and a second power source can share power to the multiple data racks, wherein the power is shared on a fractional basis. The example 400 includes a grid power source 412, and multiple secondary power sources. Each data rack includes a power cache within it, where the power cache can serve as a second power source. The data rack 410 includes a power cache 413. The data rack 430 includes a power cache 433. The data rack 432 includes a power cache 435. The data rack 434 includes a power cache 437. In embodiments, the power caches (413, 433, 435, and 437) include an array of rechargeable batteries. In embodiments, the batteries include, but are not limited to, lead-acid, nickel metal hydride (NiMH), lithium ion (Li-ion), nickel cadmium (NiCd), and/or lithium-ion polymer (Li-ion polymer) batteries.

Each data rack includes a power load. In embodiments, the power load includes, but is not limited to, a computer, a disk array, a router, a printer, a network appliance, a network termination device, a bridge, an optical transmission driver, and/or another computer peripheral. Thus, as shown in example 400, there are multiple power loads, including a first power load and a second power load. The power source can provide power to the power load and the second power load. Furthermore, the power cache can provide power to the power load and the second power load.

A controller 420 and a controller 422 communicate with the data racks (410, 430, 432, and 434) in the example 400. While two controllers are illustrated in the example 400, in practice, there can be more or fewer controllers. In embodiments, the controllers are computers that are configured to receive data from the data racks. The data can include operating parameters such as current power consumption, peak power consumption, estimated future power consumption, current operating temperature, and the like. Additionally, warnings, alarms, and/or faults can be communicated to the controllers. The warnings can include over-temperature warnings, failed component errors, and the like. In some situations, a controller can shut down or disable an entire rack based on the communicated information from the data rack. In some situations, a controller can bring a different data rack out of standby to take the place of a data rack that has been shut down.

The controllers can implement fractional power sharing and control. For example, during a peak power demand period, eighty percent of the power can be provided by a grid power source 412, while the remaining twenty percent of the power can be provided by the power caches within each data rack. During periods of lower power consumption, the power caches are recharged, enabling them to be used again during a future period of increased power demand and consumption.

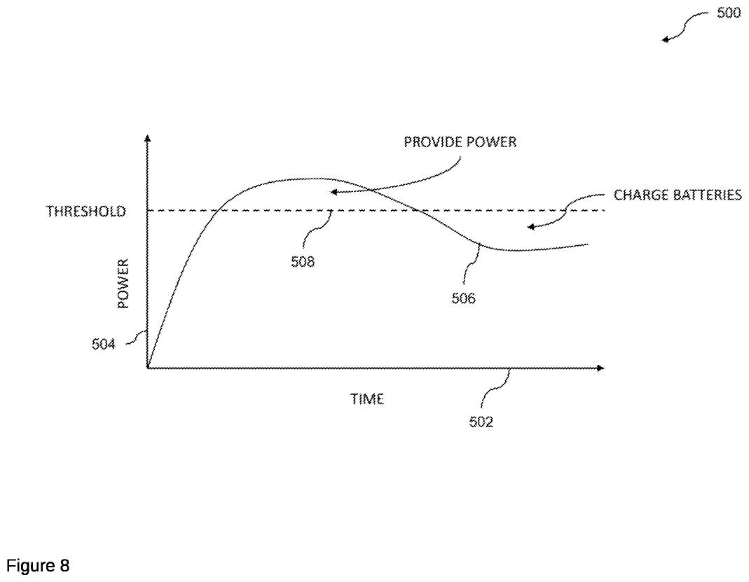

FIG. 8 shows peak shaving. Peak shaving is a technique that can be used to capture or harvest supply power when the amount of supply power available is in excess of power load requirements. The excess power can be stored for a period of time, then can be provided to supplement supply power when the amount of supply power is less than the power load requirements. The shaving of power and the providing of stored power can be controlled by one or more power policies. Peak shaving can be enabled by datacenter power management with distributed policy interaction. A graph 500 includes a horizontal axis 502 representing time and a vertical axis 504 representing power consumption of a power load (such as a datacenter group, cluster, or data rack). A predetermined threshold 508 is established based on a power policy. The power policy can be defined by an administrator at the datacenter, a local power utility, or the like. The curve 506 represents the power consumption of a power load over time. During periods where the curve 506 is above the threshold 508, power is provided to the load by the power cache. During periods where the curve 506 is below the threshold 508, the power cache is replenished. In the case where the power cache comprises one or more batteries, the batteries are charged when the curve 506 is below the threshold 508. In embodiments, enabling the power cache comprises peak shaving.

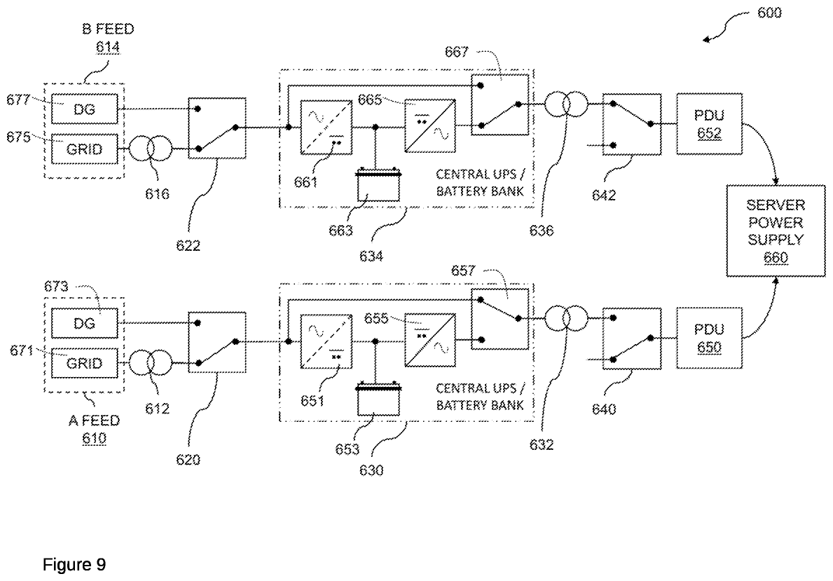

FIG. 9 illustrates 2N redundancy for power. The example 600 can employ datacenter power management with distributed policy interaction. A first set of power policies for a datacenter is defined, where the datacenter comprises a plurality of devices. A second set of power policies for the datacenter is defined. The first set of power policies is provided to a first subset of devices from the plurality of devices, and the second set of power policies is provided to a second subset of devices from the plurality of devices. Operation of the datacenter is performed based on the first set of power policies and the second set of power policies.

The example 600 includes a first main power source 610, referred to as the “A feed.” The example 600 further includes a second main power source 614, referred to as the “B feed.” Each feed is capable of powering each device in the datacenter simultaneously. This configuration is referred to as 2N redundancy for power. The A feed 610 includes a grid source 671, and a secondary, local source of a diesel generator (DG) 673. The grid source 671 is input to a power regulator 612 and then into one input of a switch block 620. The diesel generator 673 is input to a second input of the switch block 620. The switch block 620 can be configured, based on a power policy, to select the diesel generator source or the grid source. The switch block 620 feeds into a power cache 630. The power cache 630 includes an AC-DC converter 651 configured to a charge battery 653, and a DC-AC converter 655 that feeds into an input of a switch block 657. The output of the switch block 620 feeds into a second input of the switch block 657. The output of the power cache 630 is input to a power regulator 632, and then to an input of a switch block 640. The switch block 657 can be configured, based on a power policy, to provide power from the power cache, or to bypass the power cache and provide power directly from the local or grid power source. The second input of the switch block 640 is not connected, such that if the second input is selected, the A feed 610 is disconnected from the PDU 650. The PDU (Power Distribution Unit) distributes power within a datacenter and feeds the server power supply 660 of a server within a data rack in the datacenter. In embodiments, the main datacenter power is distributed to multiple power distribution units (PDUs), typically rated from 50 kVA to 500 kVA, throughout the datacenter premises. The PDU can include transformer-based and/or non-transformer distribution units. PDUs can be supplied from centralized breakers and are generally placed along the perimeter of the space, throughout the room. The PDU can have a data rack form factor that allows placement adjacent to a row of data racks enabling power distribution closer to the load. Branch circuits are distributed from the PDUs to the data racks. Each data rack enclosure uses one or more branch circuits.

Similarly, the B feed 614 includes a grid source 675, and a secondary, local source of a diesel generator (DG) 677. The grid source 675 is input to a power regulator 616 and then into one input of a switch block 622. The diesel generator 677 is input to a second input of the switch block 622. The switch block 622 can be configured, based on a power policy, to select the diesel generator source or the grid source. The switch block 622 feeds into a power cache 634. The power cache 634 includes an AC-DC converter 661 configured to a charge battery 663, and a DC-AC converter 665 that feeds into an input of a switch block 667. The output of the switch block 622 feeds into a second input of a switch block 667. The switch block 667 can be configured, based on a power policy, to provide power from the power cache, or to bypass the power cache and provide power directly from the local or grid power source. The output of the power cache 634 is input to a power regulator 636, and then to an input of a switch block 642. The second input of the switch block 642 is not connected, such that if the second input is selected, the B feed 614 is disconnected from the PDU 652, which in turn feeds the server power supply 660 of a server within a data rack in the datacenter. Thus, the A feed 610 and the B feed 614 comprise a first main power source and a second main power source. The power source and the second power source can provide 2N redundancy to the power load. Furthermore, in embodiments, the power source and a second power source share power to the multiple data racks, wherein the power is shared on a fractional basis. Embodiments include coupling a second power load to the power source. Embodiments include coupling a second power cache to the power load and the second power load. In embodiments, the power cache provides power to the power load and the second power load. Furthermore, in embodiments, the power source provides power to the power load and the second power load.

As shown in the example 600, the system is currently configured, based on a power policy, such that the A feed 610 is disconnected from the server power supply 660 based on the mode of the switch block 640. The power cache 630 is currently set to bypass mode based on the mode of the switch block 657. The power source for the A feed is currently selected as the grid source 671 based on the mode of the switch block 620.

Furthermore, as shown in the example 600, the system is currently configured, based on a power policy, such that the B feed 614 is connected to the server power supply 660 based on the mode of the switch block 642. The power cache 634 is currently set to active mode based on the mode of the switch block 667, where power is being drawn from the battery 663. Thus, the switch block 667 is configured such that the power cache is enabled. Embodiments include coupling a power cache on each of the multiple data racks within the datacenter. The enabling the power cache can include peak shaving. The power source for the B feed is currently selected as the grid source 675 based on the mode of the switch block 622.

A variety of power policies can be established based on rules and limits for power loads, power sources, and power caches. The settings of the various switch blocks can be established as execution rules when certain criteria are met. In this way, power policies can reconfigure the various switch blocks for optimal operation under a variety of dynamically changing conditions. In embodiments, the power source and the second power source provide 2N redundancy to the power load.

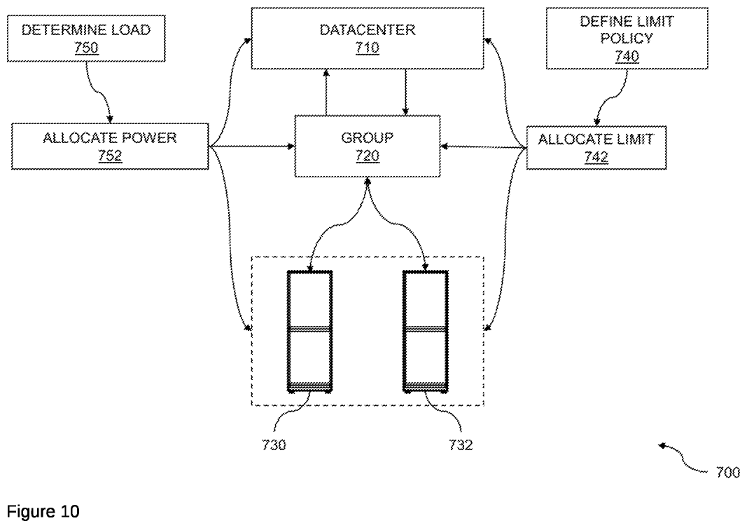

FIG. 10 shows limit allocation. Limit allocation can be associated with an amount of power required for performing operation of a datacenter, where the operation of the datacenter can be based on sets of power policies. Limit allocation can benefit from datacenter power management with distributed policy interaction. An example 700 includes a datacenter 710. The datacenter includes one or more groups, each group comprising one or more data racks. A limit policy is defined 740, which specifies a maximum amount of power that is allowed to be used. The limit is allocated 742 and provided to a group 720. In the example 700, the load is determined 750. The load can be determined based on estimated data and/or can include factors based on actual performance reported by the data racks 730 and 732. The dynamic power allocation can allocate power 752 across the multiple data racks based on time-sensitive power requirements of power for each of the data racks within the multiple data racks.

Thus, the data racks 730 and 732 can comprise a power load. The limit policies can specify the amount of available power. The power is provided to a group, and the policies are propagated to the group and its hierarchical downstream devices. The group 720 can report power information for that group upstream to the datacenter 710. Power policies can determine which racks, clusters, and/or groups are fully enabled, partially enabled, and/or disabled, based on current power availability and power load requirements.

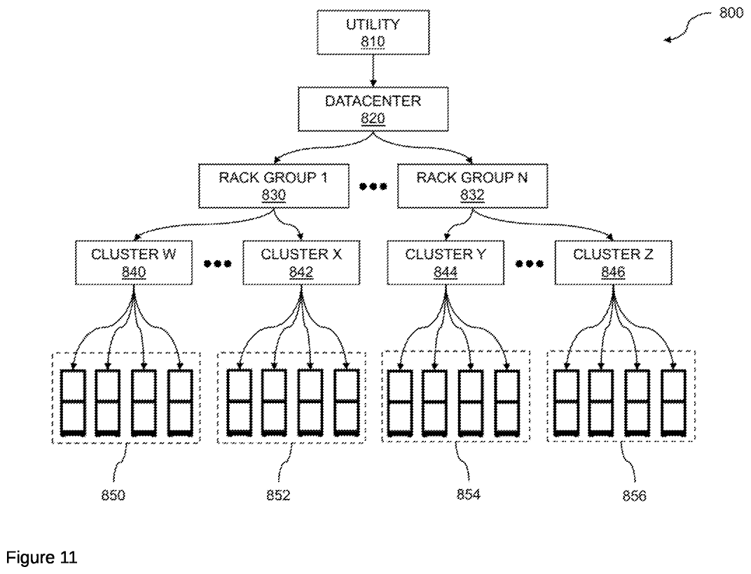

FIG. 11 illustrates hierarchical allocation of power control. Hierarchical allocation of power control can benefit from datacenter power management with distributed policy interaction. The example 800 includes a utility 810 as the top level of the hierarchy. The utility can include a local or regional energy provider. The example 800 further includes a datacenter 820 that receives power from the utility 810. Within the datacenter 820, the next downstream level of the hierarchy is the group level. The group level includes multiple groups, indicated as rack group 1 830 and rack group N 832. Each group can have a group policy. The group policy can include a hierarchical set of policies. Within the groups, the next downstream level of the hierarchy is the cluster level. The group 830 includes multiple clusters, indicated as cluster W 840 and cluster X 842. The group 832 includes multiple clusters, indicated as cluster Y 844 and cluster Z 846. Thus, in embodiments, the datacenter comprises a plurality of clusters of data racks. Each cluster includes multiple data racks. Cluster W 840 includes the data racks 850. Cluster X 842 includes the data racks 852. Cluster Y 844 includes the data racks 854. Cluster Z 846 includes the data racks 856. Thus, the datacenter can include a plurality of clusters of data racks. In embodiments, the power cache comprises multiple batteries distributed across the multiple data racks. Embodiments include dynamically allocating power from the power source across the plurality of data racks.

During operation of the system, power policies are propagated downstream from the datacenter 820 to the group level, and from the group level to the cluster level, and from the cluster level to the data rack level. The datacenter comprises multiple data racks. Operating conditions and/or power requirements are sent upstream. Thus, each data rack reports operating information to a cluster controller within its corresponding cluster. Each cluster reports operating information to a group controller within its corresponding group. Each group reports operating information to a datacenter controller. In this way, information, status, and operating conditions can quickly propagate through the system to allow power policies to act on that information in a timely manner.

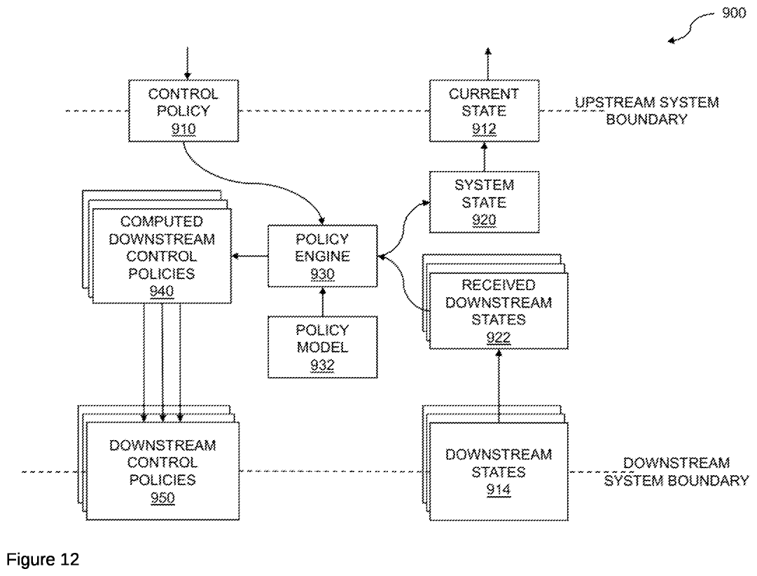

FIG. 12 shows control system internals. Control system internals can enable datacenter power management with distributed policy interaction. A first set of power policies for a datacenter and a second set of power policies for the datacenter are defined. The first set of power policies is provided to a first subset of devices, and the second set of power policies is provided to a second subset of devices. Operation of the datacenter is performed based on the first set of power policies and the second set of power policies. The example 900 includes a policy engine 930 that receives a policy model 932 and a control policy 910. This control policy can come from upstream and can be a power requirement from a higher level in the hierarchy. The control policy 910 can include an overall constraint or limit. For example, the control policy 910 can include establishing a maximum instantaneous consumption power limit of 1200 kW. The policy model 932 contains implementation rules for how to achieve the constraints of the control policy 910. For example, the policy model 932 can define rules for activating and/or deactivating power sources and/or power caches. The example 900 can include enabling the power cache to provide power to the power load when power requirements of the power load exceed limits of the power source, wherein the limits are defined by a set of power policies for the datacenter. The policy engine can then output computed downstream control policies 940 based on the policy model 932. These are passed down to the next lower hierarchy level as downstream control policies 950.

Downstream states 914 are passed upward to be received by the downstream states 922 of the policy engine 930. The downstream states can include power consumption rates, estimated power demand, operating temperatures of equipment, overheating conditions, and the like. The policy engine 930 outputs a system state 920, which is passed upstream as the current state 912. In embodiments, states include, but are not limited to, online, offline, fault, cache enabled, cache disabled, cache charging, and/or cache discharging.

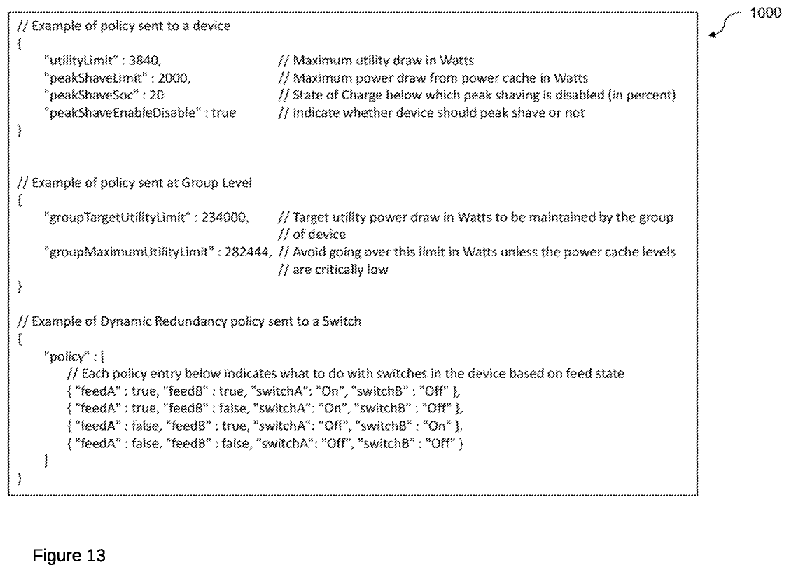

FIG. 13 illustrates JavaScript Object Notation (JSON) code for policies. The policies can include sets of policies that can be provided to subsets of devices with a datacenter. The operation of the datacenter can be performed based on the sets of power policies. Datacenter power management is enabled with distributed policy interaction. The set of power policies can include one or more of a power limit for the power source, a power limit for the power load, a minimum state of charge for the power cache, a maximum power assistance value for the power cache, or a drain rate for the power cache. As indicated in the example 1000, the policy can include a utility limit, which is a maximum utility draw in watts. The policy can include a peak shave limit, which is the maximum draw from a power cache in watts. The policy can include a peak shave state-of-charge, which is a level (in a percentage) of charge below which peak shaving is disabled. The policy can include a flag to enable or disable peak shaving.

The policy can include group level policies. In embodiments, a group level policy includes a group target utility limit, which is the target utility power draw in watts to be maintained by the group of devices. The group level policy can also include a group maximum utility limit, which represents a value to avoid exceeding unless power cache levels are critically low. In embodiments, the group policy includes a hierarchical set of policies.

The power policy can include dynamic redundancy control for switch blocks. This can include an array of rules based on the enabled/disabled state of main power sources. Given the state of the power sources, the various switch blocks (as shown in FIG. 9) can be configured for using power from or replenishing power to the power caches. Note that while the example 1000 shows a power policy implemented in JSON code, other methods of coding power policies are possible. These include, but are not limited to, a scripting language such as Python or Perl, a high-level programming language such as C or Java, and/or a table of limits and rules, such as a CSV-formatted list of limits and rules.

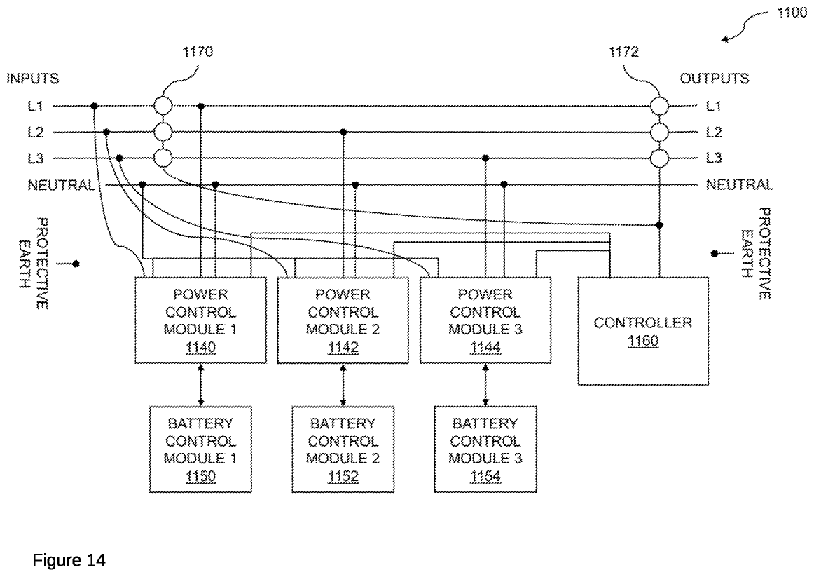

FIG. 14 shows a system for datacenter power bursting. Datacenter power bursting can be enabled by datacenter power management with distributed policy interaction. Sets of power policies can be defined and provided to subsets of devices within the datacenter. The operation of the datacenter can be performed based on the sets of power policies. The system 1100 is a block diagram for power control module usage. One or more power control modules can be used convert or to store excess power, where the stored excess power can be used to meet an AC current requirement that can be in excess of available power. Power control module usage enables datacenter current injection for power management. A datacenter power policy is developed, and a supply capacity from a UPS is allocated. An AC current requirement is detected by one or more power control blocks, and AC current is injected into the output network of a UPS, by the power control blocks, based on the detecting and the datacenter power policy. Power control modules, such as power control module 1 1140, power control module 2 1142, and power control module 3 1144, can be coupled to one or more phases of input power. In the example shown, input three-phase power is shown. The one or more power control modules further can be coupled to neutral and protective earth. The one or more control modules can be coupled to one or more battery control modules such as battery control module 1 1150 coupled to power control module 1, battery control module 2 1152 coupled to power control module 2, battery control module 3 1154 coupled to power control module 3, and so on. Battery control modules are also parallelable in order to create a range of energy storage capacity options for any given power capacity associated with a power control module. A power control module and a battery control module can comprise a power control block.

The one or more power control modules can be controlled by a controller 1160. The controller can monitor current at the line inputs using one or more current sensors such as current sensor 1170. The controller can control storage of available AC power from the line inputs within batteries or capacitors, conversion of AC power to DC power, and DC power conversion to AC power using injection of AC current into an output power system, and so on. The controller can monitor an amount of AC current in an output network using one or more current sensors, such as current sensor 1172. Current sensors can be included within physical boundaries of the unit represented by the system block diagram 1100, or they can be moved external to the physical boundaries to support primary and auxiliary unit functionality. In embodiments, the AC current that can be injected by the one or more power control blocks can be sourced by at least one of the one or more power caches. A power cache can include one or more batteries, one or more capacitors, and so on, as part of the battery control modules 1150, 1152, and 1154. The power control blocks can be managed or controlled by the datacenter power policy, where the datacenter power policy can be issued to individual hardware components within a datacenter topology. The power control module system block diagram 1100 can describe elements of an energy block for use in datacenter power management.

Each power control module of the system 1100 can include a battery charging unit and a current mode grid tie inverter unit. The current mode grid tie inverter unit can enable current injection into a phase of the three-phase datacenter power grid at a constant voltage for the phase. The current mode grid tie inverter unit can enable current injection into a phase of the three-phase datacenter power grid at an in-phase AC frequency for the phase. The current mode grid tie inverter unit can inject current using pulse width modulation control. The pulse width modulation can be used to condition energy from the battery modules. The battery charging unit of power control modules 1140, 1142, and 1144 can be an integrated form of battery control modules 1150, 1152, and 1154, respectively, such that power control modules and/or battery control modules and/or power caches can be packaged in a discrete unit. Alternatively, the battery control modules can include the power caches, or they can be separately packaged. The battery modules can source energy for the power control modules.

The datacenter power management apparatus can enable power bursting within the datacenter. Power bursting is needed when either instantaneous load current requirements and/or instantaneous power grid source current availability cannot be met by a typical datacenter power topology. The inability can be based on latencies, impedances, current limits, and so on. The controller 1160 can manage operational modes for the datacenter power management apparatus, including modes for enabling power bursting, SLA fulfillment, redundancy requirements, etc. The operational modes can include charging and energy injection. The operational modes can be determined by a datacenter power management policy. The datacenter power management policy can enable power supply redundancy within the datacenter. The datacenter power management apparatus can be colocated with datacenter loads, and the colocation can be within a datacenter rack.

The power control modules can include communication signal inputs coupled to the controller 1160. The communication signal inputs can enable datacenter power policy execution. The controller 1160 can provide real-time or near-real-time response to current sense point sensors 1170 or 1172, whereas an overall datacenter processor running an overall datacenter policy may not be able to respond in real time due to processor and communication latencies.

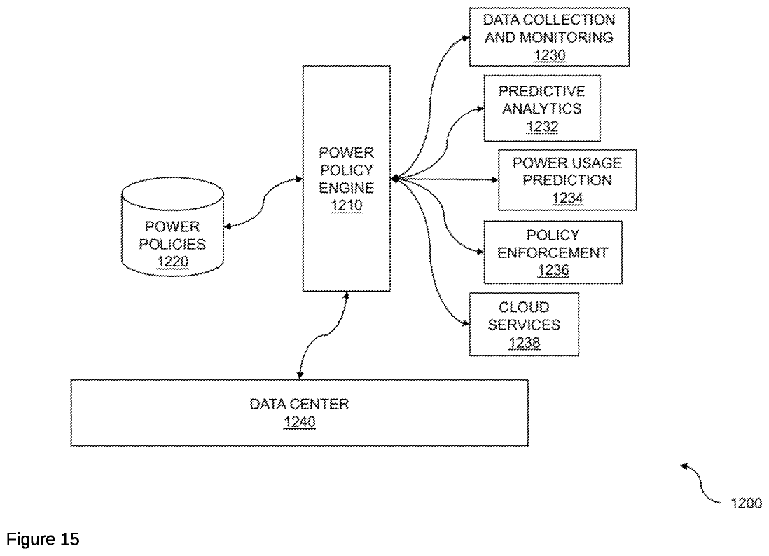

FIG. 15 illustrates processing of software-defined power policies. Software-defined power can be based on collecting and analyzing datacenter operations data. The datacenter operations data can include power data such as power source data and power load requirement data. The operations data can include operating policies, allocation policies, service level agreements (SLAs) and so on. Software-defined power policies support datacenter power management with distributed policy interaction. A first set of power policies is defined for a datacenter, and a second set of power policies is defined for the datacenter. The datacenter includes one or more devices. The first set of power policies is provided to a first subset of devices, and the second set of power policies is provided to a second subset of devices. Operation of the datacenter is performed based on the first set of power policies and the second set of power policies.

Software-defined policies are processed 1200 for managing power within a data center. A datacenter 1240 can be managed using time-varying techniques by a power policy engine 1210. The power policy engine can include one or more processors, servers, blade servers, cloud servers, and so on. The one or more processors or one or more servers can be located within the datacenter, remotely from the datacenter, in the “cloud”, and the like. The power policy engine 1210 can access power policies 1220. The power polices can include one or more of power arrangements, power configurations, service level agreements, dynamic service level agreements, and so on. The allocation policies can be stored in a networked database, where the networked database can include a structured query language (SQL) database. The allocation policies can include power source limits, such as grid power limits, renewable micro-grid power limits, power source availability, and so on. The power policies, including allocation or arrangement policies, can include criteria such as power consumption limits, switch configurations, datacenter condition criteria, etc. In a usage example, when conditions that allow peak shaving to take place and when surplus power exists, the power policies can identify datacenter switches and configurations for those switches to allow replenishing of the power caches or other backup power.

The identifying of datacenter situations, the determining of policy priorities, and the modifying of power arrangements, etc., can be performed by the power policy engine based on several techniques. The techniques can be time varying. The power policy engine can use data collection and monitoring 1230. Data collection and monitoring can include power source availability, power load needs, power component operating health, and so on. The data collection and monitoring can occur at the electrical equipment level where the electrical equipment can include servers, switches, uninterruptable power supplies (UPSs), batteries, etc. The data collection and monitoring can occur at the data rack (IT rack) level, for a cluster of racks, for a cage, etc. The power policy engine can use predictive analytics 1232. The predictive analytics can use data obtained from the datacenter as the datacenter is in operation, as well as historical data, to determine power usage trends. The predictive analytics can be used to generate a value related to each power source, power load, switch, etc., where the value can be a score, a percentage, and so on. The predictive analytics can be used to determine trends in power usage.

The power policy engine can use power usage prediction 1234. The power usage prediction can be based on historical power usage or present power usage, and can include other usage information such as anticipated client usage, processing job mix, seasonal factors such as lighting and cooling, and so on. The power policy engine can use policy enforcement 1236. Policy enforcement can be based on a service level agreement, a variable SLA, a dynamic SLA, etc. The policy enforcement can be used to provide power required by the SLA to throttle down power to datacenter equipment such as datacenter racks when higher priority jobs or SLAs are encountered, and the like. The power policy engine can use cloud services 1238. Cloud services can include storage services for storing power policies, as described elsewhere. The cloud services can include determining or identifying services, where the determining a priority or identifying a situation can be performed in the cloud using cloud-based servers, and so on.

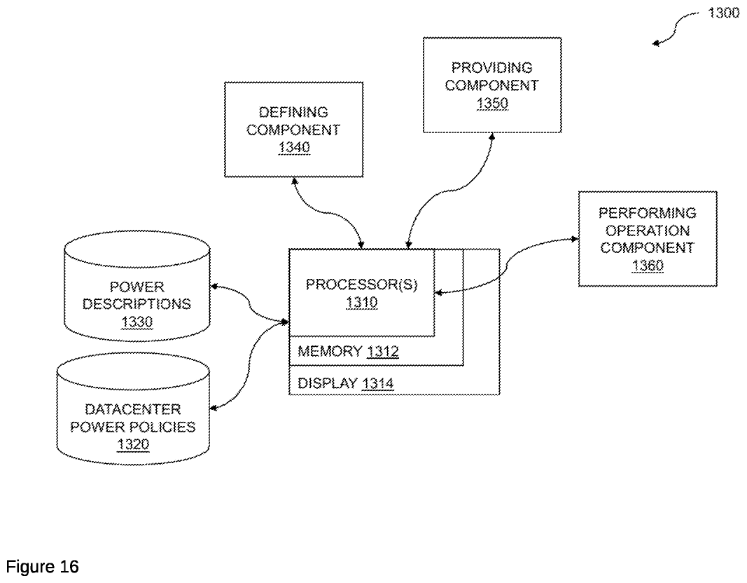

FIG. 16 is a system diagram for power management with distributed policy interaction. The system 1300 can implement datacenter power management with distributed policy interaction. The system 1300 can include one or more processors 1310 and a memory 1312 which stores instructions. The memory 1312 is coupled to the one or more processors 1310, where the one or more processors 1310 can execute instructions stored in the memory 1312. The memory 1312 can be used for storing instructions; for storing databases of power sources, power caches, and power loads; for storing information pertaining to load requirements; for storing information pertaining to redundancy requirements; for storing power policies; for system support information; and the like. Information about the various power policies can be shown on a display 1314 connected to the one or more processors 1310. The display can comprise a television monitor, a projector, a computer monitor (including a laptop screen, a tablet screen, a netbook screen, and the like), a cell phone display, a mobile device, or another electronic display.

The system 1300 includes power policies 1320. In embodiments, the power policies 1320 are stored in a networked database, such as a structured query language (SQL) database. The power policies can be stored in local storage, in remote storage, in cloud-based storage, and so on. The power policies 1320 can include limits, such as power consumption limits, as well as switch configurations when certain conditions are met. For example, when conditions allow peak shaving to take place, and surplus power exists, the power policies can identify switches and their configurations to allow replenishing of power caches, where the power caches can include batteries, capacitors, supercapacitors, etc. The power policies can include a first set of power polices and a second set of power policies. In embodiments, the first set of power policies and the second set of power policies can accomplish prioritization for customer applications running within the datacenter to enable service level agreement support for the customer applications within the datacenter. The power policies can be associated with one or more compensation offers. Discussed throughout, a compensation offer can be requested when an exception to processing prioritization is required. The exception can include increasing execution priority, decreasing execution priority, etc. The compensation offer can include a cost, an incentive, an option, and the like. The system 1300 includes power descriptions 1330. The power descriptions 1330 can include, but are not limited to, power descriptions of power loads, power caches, power supplies, rack power profiles, batteries, buses, circuit breakers, fuses, and the like. The power descriptions can include physical space needs, electrical equipment cooling requirements, maintenance requirements, service histories, etc.

The system 1300 includes a defining component 1340 that defines one or more sets of power policies. In embodiments, the defining component defines a first set of power policies for a datacenter where the datacenter comprises a plurality of devices. The power polices that are defined can be uploaded by a user, obtained from datacenter power policy storage 1320, downloaded over a computer network such as the Internet, and so on. In further embodiments, the defining component defines a second set of power policies for the datacenter. The second set of power policies can be defined using the same defining component used to define the first set of power policies or a different defining component. In other embodiments, further sets of power policies can be defined, such as a third set of power policies, a fourth set of power policies, and so on. The third set of power policies, the fourth set of power policies, etc., can be used to replace the first set of power policies, the second set of power policies, and the like. In embodiments, the first set of power policies can define requirements for the first subset of devices. The defining requirements can include processing requirements, storage requirements, scheduling requirements, priorities, and so on. In other embodiments, the second set of power policies can define optional requirements for the second subset of devices. Optional requirements can include a requirement such as to use a faster processor if one is available and otherwise to use a slower processor. The policies can remain constant or can be modified, replaced, updated, and so on. In embodiments, the first set of policies can vary over time. Similarly, the second set of policies can vary over time.

The system 1300 can further include a providing component 1350. The providing component provides the first set of power policies to a first subset of devices from the plurality of devices. The first subset of devices can include processors, servers, storage units, networking equipment, and so on. The providing component further provides the second set of power policies to a second subset of devices from the plurality of devices. The second subset of devices can also include devices similar to the first subset of devices or to different devices. In embodiments, the providing the first set of power policies to a first subset of devices and the providing the second set of power policies to a second subset of devices can be accomplished by broadcasting. Discussed above and throughout, sets of power policies can accomplish prioritization for customer applications. The prioritization enables service level agreement support and other contractual agreements associated with customer applications. Further embodiments include receiving communication from the first subset of devices in response to the providing the first set of power policies. The communication can include acceptance of the power policies. In other embodiments, the communication received from the first subset of devices comprises a request for an exception from the first set of power policies. An exception can include a request for a higher processing priority, an earlier processing date or time, and the like. In embodiments, the request for the exception from the first set of power policies can be accompanied by a first compensation offer. The compensation offer can include a bid, a price, a credit or debit, etc. The compensation offer can be accepted, rejected, countered with another offer, etc.

The system 1300 can include a performing operation component 1360 that performs operation of the datacenter based on the first set of power policies and the second set of power policies. The performing can include allocating processors, servers, and storage devices; allocating power to the various devices; configuring networking equipment; suspending lower priority tasks; and so on. Embodiments further include performing a power capability matching between the request for the exception from the first set of power policies and the acceptance of the second set of power policies. The power capability matching can be based on a capability match, on the best near-match, on the soonest available match, and the like. Other embodiments include a compensation matching between the first compensation offer and the second compensation offer. The matching compensation offers can include a first client offering to lower priority of their processing jobs for a level of compensation, and a second client accepting higher priority of their processing jobs at the level of compensation. The power capability matching can be a basis for defining further sets of power policies such as a third set of power policies, a fourth set of power policies, and so on. The third set of power policies can replace the first set of power policies, and the fourth set of power policies can replace the second set of power policies.

The system 1300 includes a computer system for power management comprising: a memory which stores instructions; one or more processors attached to the memory wherein the one or more processors, when executing the instructions which are stored, are configured to: define a first set of power policies for a datacenter wherein the datacenter comprises a plurality of devices; define a second set of power policies for the datacenter; provide the first set of power policies to a first subset of devices from the plurality of devices; provide the second set of power policies to a second subset of devices from the plurality of devices; and perform operation of the datacenter based on the first set of power policies and the second set of power policies.

Disclosed embodiments include a computer program product embodied in a non-transitory computer readable medium for power management, the computer program product comprising code which causes one or more processors to perform operations of: defining a first set of power policies for a datacenter wherein the datacenter comprises a plurality of devices; defining a second set of power policies for the datacenter; providing the first set of power policies to a first subset of devices from the plurality of devices; providing the second set of power policies to a second subset of devices from the plurality of devices; and performing operation of the datacenter based on the first set of power policies and the second set of power policies.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate, the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for managing negotiation for resource provision in a datacenter, the method comprising:
providing a resource to devices in the datacenter, wherein a controller in the datacenter manages provision of the resource to the devices in the datacenter;
determining a resource modification condition in the datacenter;
formulating a resource modification and an offer of compensation based, at least in part, upon the resource modification condition;
communicating the resource modification and the offer of compensation in exchange for the resource modification to the devices;
receiving a rejection of the offer of compensation from zero or more of the devices;
receiving an acceptance of the offer of compensation from zero or more of the devices;
implementing the resource modification to accepting devices; and
distributing compensation to the accepting devices according to the offer of compensation.

2. The computer-implemented method of claim 1 wherein the resource comprises at least one of power, data, or HVAC services.

3. The computer-implemented method of claim 1, further comprising:
after receiving the acceptance of the offer of compensation from the devices:
determining whether or not the resource modification condition persists;
if the resource modification condition persists, formulating an updated resource modification and an offer of compensation based, at least in part, upon the resource modification condition that persists;
communicating the offer of compensation to the devices;
receiving a rejection of the offer of compensation from zero or more of the devices;
receiving an acceptance of the offer of compensation from zero or more of the devices;
implementing the resource modification to accepting devices; and
collecting compensation from the accepting devices according to the offer of compensation.

4. The computer-implemented method of claim 1 wherein the resource modification condition is determined based, at least in part, upon at least one of a cost of the resource and an availability of the resource.

5. The computer-implemented method of claim 1 wherein the offer of compensation comprises at least one of an offer of money, an in-kind contribution, schedule modification of a financial obligation, a modification of a fee, or a service.

6. The computer-implemented method of claim 1, further comprising establishing a contractual obligation with one or more of the devices, wherein the contractual obligation comprises at least one of: a preemptive acceptance of the offer of compensation provided the offer of compensation meets predefined criteria, an order of communicating the offer of compensation to the devices, and an additional incentive in exchange for accepting the offer of compensation automatically.

7. The computer-implemented method of claim 1 wherein formulating the resource modification comprises calculating a cost benefit associated with the resource modification based, at least in part, upon a quantity of the resource saved by the resource modification request and a number of the accepting devices.

8. The computer-implemented method of claim 7, further comprising forecasting a likelihood of acceptance for individual devices and calculating the cost benefit associated with the resource modification based, at least in part, upon the likelihood of acceptance for the individual devices.

9. The computer-implemented method of claim 1, further comprising:
selecting among the devices a group of devices to which the offer of compensation is made; and
withholding the offer of compensation from devices not in the group.

10. A system for managing negotiation of resources in a datacenter, comprising:
a controller configured to provide a resource to one or more devices in the datacenter, the resource comprising at least one of power and data, and wherein the controller is further configured to communicate with the one or more devices, and further wherein the controller is configured to modify provision of the resource to the device;
a processor; and
a memory storing one or more computer-readable instructions executable by the processor to perform acts comprising:
establishing a resource modification goal for the devices, the resource modification goal defining a modification of provision of the resource to the devices;
formulating an offer for one or more of the devices, the offer comprising a resource modification and a compensation offer in exchange for the resource modification;
communicating the offer to the one or more devices;
receiving an answer to the offer from the one or more devices;
implementing the resource modification to one or more of the devices accepting the offer; and
distributing the compensation to the one or more of the devices accepting the offer.

11. The system of claim 10 wherein the compensation comprises one or more of money, an in-kind contribution, or a service.

12. The system of claim 10, the acts further comprising:
reformulating the offer by strengthening the offer based, at least in part, upon one or more devices rejecting the offer; and
communicating the offer to the devices rejecting the offer.

13. The system of claim 10 wherein establishing the resource reduction goal comprises detecting a resource modification condition caused by a change in at least one of a cost or an availability of the resource.

14. The system of claim 10 wherein one or more of the devices is configured to preemptively accept the offer.

15. The system of claim 14 wherein one or more of the devices is configured to preemptively accept the offer provided at least one of the resource reduction and the compensation offer are within predetermined parameters.

16. The system of claim 10 wherein the resource modification comprises one or more of: a device consuming more of the resource in exchange for compensation by the device to the controller; or a device consuming less of the resource in exchange for compensation by the controller to the device.

17. A system for managing negotiation of resources in a datacenter, comprising:
a controller configured to provide power to one or more devices in the datacenter, and wherein the controller is further configured to communicate with the one or more devices, and further wherein the controller is configured to modify provision of the power to the device;
a processor; and
a memory storing one or more computer-readable instructions executable by the processor to perform acts comprising:
monitoring at least one of a cost and an availability of power;
if cost or availability of power exceeds a predefined threshold, identifying a power modification condition having a quantifiable power reduction goal based, at least in part, upon at least one of the cost and availability of power;
based at least in part upon the power modification condition, formulating a reduction offer to one or more of the devices, wherein the reduction offer includes a power reduction and a compensation;
communicating the reduction offer to one or more of the devices;
receiving an affirmative answer from one or more of the devices;
in response to the affirmative answer, implementing the power reduction and delivering the compensation.

18. The system of claim 17, further comprising formulating reduction offers to the devices until a sufficient number of the devices accepts and is subject to the power reduction that the power modification condition ends.
